(19) United States
(12) Patent Application Publication
(10) Pub. No.: US 2018/0235199 A1
(43) Pub. Date: Aug. 23, 2018

(54) FISH PICK DEVICE AND METHOD

(71) Applicant: Njadl Sikveland, Circle, MT (US)

(72) Inventor: Njadl Sikveland, Circle, MT (US)

(21) Appl. No.: 15/813,150

(22) Filed: Nov. 14, 2017

Related U.S. Application Data
(60) Provisional application No. 62/462,900, filed on Feb. 23, 2017.

(51) Int. Cl. A01K 97/00

(52) U.S. Cl. CPC A01K 97/00

(57) ABSTRACT

A fish pick and method includes a fish pick, the device has a 0.25 inch diameter rod made of stainless steel and formed into a shape configured to support a handle and a fish having a rod handle support including a rigidly coupled handle, a rod guard support including a removably couplable guard having at least one notch, a rod base, and a rod fish support extending from the rod base and offset twenty degrees from the rod guard support. The rod fish support is configured to hold a fish by insertion into the fish's gills and exiting the fish's mouth.

### CROSS-REFERENCE TO RELATED APPLICATION(S)

The present application is related to and claims priority to U.S. Provisional Patent Application No. 62/462,900 filed 2017 Feb. 23, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of fishing of existing art and more specifically relates to a fish pick device and method.

### RELATED ART

Many people enjoy fishing. Fishing is the activity of trying to catch fish. Fish are normally caught in the wild. Techniques for catching fish include hand gathering, spearing, netting, angling, and trapping. Fishing may also include catching aquatic animals other than fish, such as crustaceans and the like. Fishermen also enjoy taking pictures with the fish they catch to document the achievement.

It can be difficult for fishermen and fish handlers to hold onto a fish by its mouth when unhooking the fish, posing for a picture, or even transporting the fish to a cleaning table or live well. Unfortunately, some fish may instinctively bite or stab fishermen with their dorsal fins or catfish barbs or attempt to squirm away. Fishermen and fish handlers may also accidentally cut their fingers on the inside of a fish's gill trying to get a good grip. A suitable solution is desired.

U.S. Pat. No. 4,620,386 to Hare relates to a method and apparatus for gripping a fish. The described method and apparatus for gripping a fish includes a method of orienting a fish using a pair of tine members and a pair of jaw members. The pair of tine members are simultaneously inserted into the respective gills of a fish, entering the gills from outside the fish. The jaw members are clamped around the torso of the fish directly below the fish's gills and at an acute angle with respect to the path of insertion of the tine members.

### SUMMARY OF THE INVENTION

In view of the foregoing disadvantages inherent in the known holding (fishing, trapping and vermin destroying) art, the present disclosure provides a novel fish pick. The general purpose of the present disclosure, which will be described subsequently in greater detail, is to provide a fish pick configured to safely hold a live fish.

A fish pick and method is disclosed herein. The fish pick and method includes a fish pick, the device preferably comprising a 0.25 inch diameter rod made of stainless steel and formed into a shape within a vertical plane configured to support a handle and a fish. The rod has a vertical rod support including a rigidly coupled handle, a vertical rod guard support including a removably couplable guard having at least one notch, a rod base, and a rod fish support extending from the rod base and offset twenty degrees from the rod guard support. The rod fish support is configured to hold a fish by insertion into the fish's gills and exiting the fish's mouth.

According to another embodiment, a fish pick method of use is also disclosed herein. The fish pick and method includes inserting the rod fish support into the gill of a fish and holding a fish by the handle. The method of use further comprising the steps of holding the fish's body with a second hand and releasing the fish.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a fish pick, constructed and operative according to the teachings of the present disclosure.

FIG. 1 is a view of the fish pick during an ‘in-use’ condition, according to an embodiment of the disclosure.

FIG. 2 is a perspective view of the fish pick of FIG. 1, according to an embodiment of the present disclosure.

FIG. 3 is a perspective view of the fish pick of FIG. 1, according to an embodiment of the present disclosure.

FIG. 4 is a perspective view of the fish pick of FIG. 1, according to an embodiment of the present disclosure.

FIG. 5 is a flow diagram illustrating a method of use for the fish pick, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a holding (fishing, trapping and vermin destroying) and more particularly to a fish pick as used to improve the means by which to safely hold a live fish. Generally speaking, disclosed is a fish pick configured to safely hold a live fish while protecting the user from the fish.

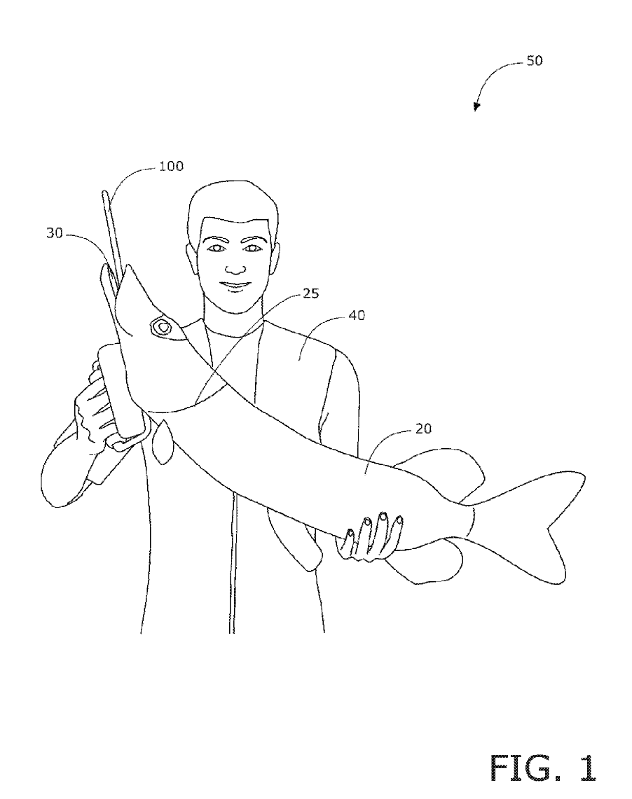

Referring now more specifically to the drawings by numerals of reference, there is shown in FIGS. 1-4, various views of a fish pick 100.

FIG. 1 shows a fish pick 100 during an ‘in-use’ condition 50, according to an embodiment of the present disclosure. Here, fish pick 100 may be beneficial for use by a user 40 to safely hold a live fish 20 by inserting the fish pick 100 into gill 25 through mouth 30 of fish 20. As illustrated, fish pick 100 may include handle 112 and rod 110.

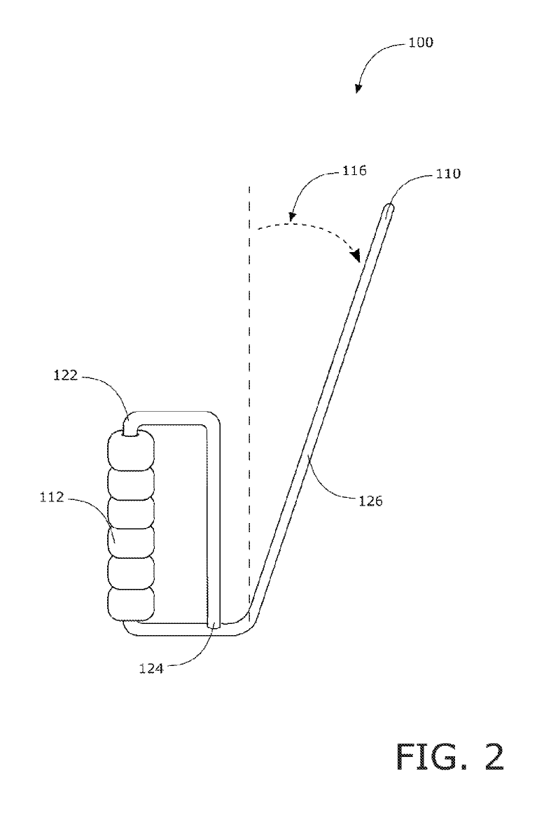

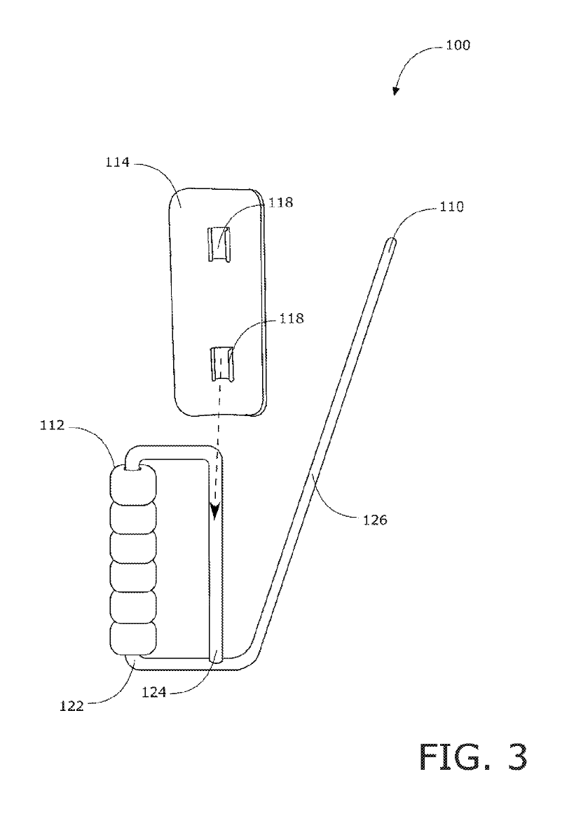

FIG. 2 shows a perspective view of fish pick 100 according to an embodiment of the present disclosure. As illustrated, fish pick 100 may include handle 112 rigidly coupled to rod handle support 122 of rod 110. Rod 110 is preferably made of stainless steel and shaped within a vertical plane to provide rod fish support 126 that holds fish 20 via rigid connection to rod handle support 122. Rod fish support 126 has a tapered end for ease of insertion and is offset from vertical by angle 126 when handle 112 is held vertically. In the preferred embodiment handle 112 is comprised of wood. In alternate embodiments handle 112 comprises metal or plastic. Rod 110 is configured to provide rod fish support 126 that holds fish 20 via rigid connection to rod handle support 122. FIG. 3 is a perspective view of the fish pick of FIG. 1, according to an embodiment of the present disclosure.

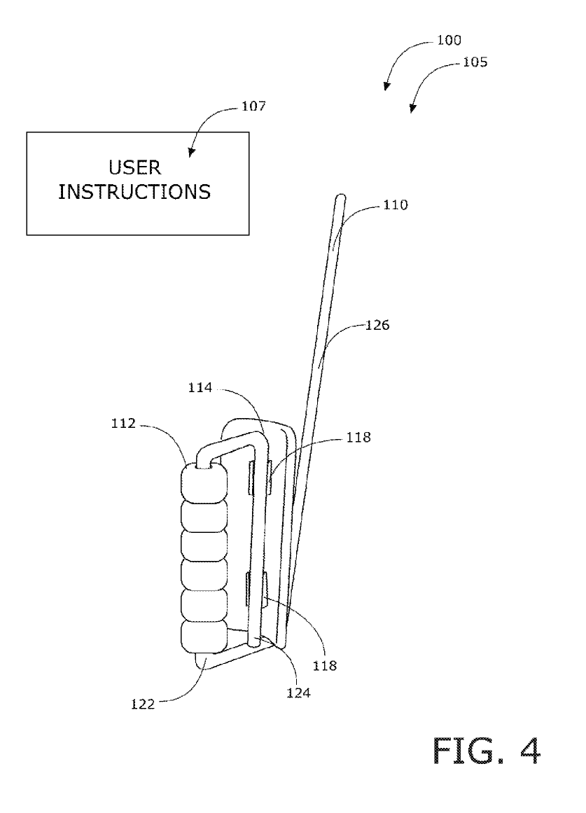

FIG. 4 shows a perspective view of fish pick 100 according to an embodiment of the present disclosure. As illustrated, fish pick 100 may include handle 112 rigidly coupled to rod handle support 122 of rod 110. Rod guard support 124 is removably couplable to guard 114 by at least one notch 118. At least one notch 118 grips rod guard support 124 forming the removably coupleable connection. Guard 114 is configured to protect user 40 from fish 20 by providing a barrier between fins, teeth, and objects such as catfish barbs while holding fish 20. In the preferred embodiment guard 114 is comprised of plastic. In an alternate embodiment guard 114 comprises metal. Rod 110 is shaped within a vertical plane to provide rod fish support 126 that holds fish 20 via rigid connection to rod handle support 122. According to one embodiment, the fish pick 100 may be arranged as a kit 105. In particular, the fish pick 100 may further include a set of instructions 107. The instructions 107 may detail functional relationships in relation to the structure of the fish pick 100 such that the fish pick 100 can be used, maintained, or the like, in a preferred manner.

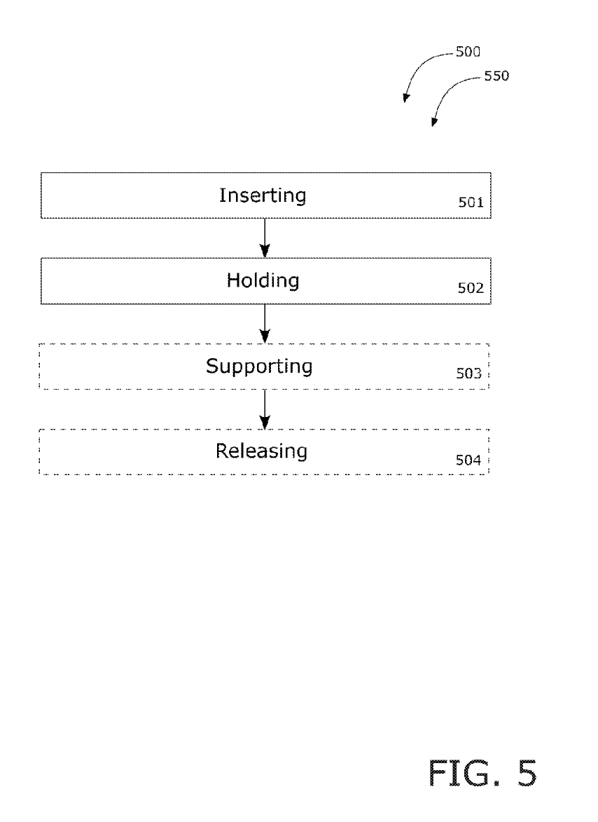

FIG. 5 is a flow diagram 550 illustrating a method of use 500 for fish pick 100, according to an embodiment of the present disclosure. In particular, the method of use 500 may include one or more components or features of the fish pick 100 as described above. As illustrated, the method of use 500 may include the steps of: step one 501, inserting rod fish support 126 into gill 25 of fish 20 and step two 502, holding fish 20 by with handle 112. The method of use 500 may further comprising the steps of step three 503, holding the body of fish 20 with a second hand and step four 504, releasing fish 20 by removing the fish pick 100 from gill 25.

It should be noted that steps 503 and 504 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods of use for fish pick 100 are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A fish pick, the fish pick comprising:
a 0.25 inch diameter rod made of stainless steel and formed into a shape within a vertical plane, configured to support a handle and a fish including a vertical rod handle support having a rigidly coupled handle, a vertical rod guard support including a removably couplable guard having at least one notch, a horizontal rod base, and a rod fish support extending from the rod base and offset twenty degrees from the rod guard support, the rod fish support configured to hold a fish by insertion into the fish's gills and exiting the fish's mouth.

2. The fish pick of claim 1, wherein the guard comprises plastic.

3. The fish pick of claim 1, wherein the guard comprises metal.

4. The fish pick of claim 1, wherein the handle comprises wood.

5. The fish pick of claim 1, wherein the handle comprises plastic.

6. The fish pick of claim 1, wherein the handle comprises metal.

7. A fish pick, the fish pick comprising:
a 0.25 inch diameter rod made of stainless steel and formed into a shape within a vertical plane, configured to support a handle and a fish including a vertical rod handle support having a rigidly coupled handle, a vertical rod guard support including a removably couplable guard having at least one notch, a horizontal rod base, and a rod fish support extending from the rod base and offset twenty degrees from the rod guard support, the rod fish support configured to hold a fish by insertion into the fish's gills and exiting the fish's mouth;
wherein the guard comprises plastic; and
wherein the handle comprises wood.

8. The fish pick of claim 7, further comprising set of instructions; and
wherein the fish pick is arranged as a kit.

9. A fish pick method of use, the method comprising the steps of:
inserting the rod fish support into the gill of a fish; and
holding a fish by the handle.

10. The method of claim 9, further comprising the steps of
holding the fish's body with a second hand and
releasing the fish.
